(19) United States
(12) Patent Application Publication
(10) Pub. No.: US 2020/0128552 A1
(43) Pub. Date: Apr. 23, 2020

(54) METHOD AND APPARATUS FOR ASSESSING INTERFERENCE EFFECT EXERTED BY MOBILE COMMUNICATION SYSTEM ON FIXED SYSTEM BASED ON TIME PERCENTAGE

(71) Applicant: ELECTRONICS AND TELECOMMUNICATIONS RESEARCH INSTITUTE, Daejeon (KR)

(72) Inventors: Ho Kyung SON, Daejeon (KR); Young Jun CHONG, Daejeon (KR); Sung Woong CHOI, Daejeon (KR); Heon Jin HONG, Daejeon (KR)

(21) Appl. No.: 16/205,082

(22) Filed: Nov. 29, 2018

(30) Foreign Application Priority Data
Oct. 18, 2018 (KR) 10-2018-0124173

(51) Int. Cl. H04W 72/08; H04W 72/04; H04B 7/185

(52) U.S. Cl. CPC H04W 72/082; H04B 7/185; H04W 72/0453

(57) ABSTRACT

Provided is a method of assessing an interference effect, the method including setting, to determine an interference effect exerted by at least one communication device of a first wireless communication network on a fixed communication device previously arranged in a second wireless communication network, a parameter associated with the communication device of the first wireless communication network and the communication device of the second wireless communication network, generating, for each snapshot, an arrangement state of the communication device of the first wireless communication network arranged based on the communication device of the second wireless communication network, and assessing an interference effect of the communication device of the first wireless communication network on the communication device of the second wireless communication network on a time-by-time basis.

### CROSS-REFERENCE TO RELATED APPLICATION(S)

This application claims the priority benefit of Korean Patent Application No. 10-2018-0124173 filed on Oct. 18, 2018, in the Korean Intellectual Property Office, the disclosure of which is incorporated herein by reference for all purposes.

### BACKGROUND

### 1. Field

One or more example embodiments relate to a method and an apparatus for assessing an interference effect exerted by a mobile communication system on a fixed system based on a time percentage and, more particularly, to a method and an apparatus for assessing an interference effect by applying a parameter changing on a time-by-time basis.

### 2. Description of Related Art

In a typical interference effect assessing method, a fixed beam pattern between a base station and a terminal constituting a mobile communication system may be used to assess an interference effect exerted by the mobile communication network on a heterogeneous wireless communication network. However, since a movement of the terminal changed in real time, there is a limit to the interference effect assessing method using the fixed beam pattern. The base station may track the movement of the terminal in real time so as to construct a beam pattern and transmit data. Accordingly, there is a desire for a method of assessing an interference effect exerted by a mobile communication system on a fixed system by applying a parameter of the fixed system and the mobile communication system changing over time.

### SUMMARY

An aspect provides an interference effect assessing method to assess an interference effect exerted by a mobile communication system on a fixed system based on a time percentage.

Another aspect also provides an interference effect assessing method to provide a good quality service by analyzing an interference effect exerted by a mobile communication system on a fixed system using the same frequency band or a neighboring frequency band as compared to that of the mobile communication system.

According to an aspect, there is provided a method of assessing an interference effect, the method including setting, to determine an interference effect exerted by at least one communication device of a first wireless communication network on a fixed communication device previously arranged in a second wireless communication network, a parameter associated with the communication device of the first wireless communication network and the communication device of the second wireless communication network, generating, for each snapshot, an arrangement state of the communication device of the first wireless communication network arranged based on the communication device of the second wireless communication network, and assessing an interference effect of the communication device of the first wireless communication network on the communication device of the second wireless communication network on a time-by-time basis.

In the arrangement state, the communication device of the first wireless communication network may be arranged beyond a separation distance from the communication device of the second wireless network within a simulation distance.

The method may further include determining an adequacy of the separation distance by determining whether an interference effect of the arranged communication device of the first wireless communication network on the communication device of the second wireless communication network satisfies an acceptable interference criterion.

The communication device of the first wireless communication network and the communication device of the second wireless communication network may use a same frequency band or neighboring frequency bands.

The parameter may include a transmission power and a beamforming gain of the communication device of the first wireless communication network, an antenna gain of the communication device of the second wireless communication network, and a path loss between the communication device of the first wireless communication network and the communication device of the second wireless communication network.

The assessing of the interference effect may include assessing the interference effect on the time-by-time basis using an interference signal intensity corresponding to the communication device of the first wireless communication network for each time step given for each snapshot.

The interference signal intensity may be determined based on an antenna gain of the communication device of the second wireless communication network and a path loss between the communication device of the first wireless communication network and the communication device of the second wireless communication network.

According to another aspect, there is also provided a method of assessing an interference effect, the method including setting, to determine an interference effect exerted by a fixed communication device previously arranged in a second wireless communication network on at least one communication device to be arranged in a first wireless communication device, a parameter associated with the communication device of the first wireless communication network and the communication device of the second wireless communication network, generating, for each snapshot, an arrangement state of the communication device of the first wireless communication network to be arranged beyond a separation distance within a simulation distance based on the communication device of the second wireless communication network, and assessing an interference effect exerted by the communication device of the second wireless communication network on the communication device of the first wireless communication network on a time-by-time basis.

The communication device of the first wireless communication network and the communication device of the second wireless communication network may use a same frequency band or neighboring frequency bands.

The parameter may include a transmission power and a beamforming gain of the communication device of the first wireless communication network, an antenna gain of the communication device of the second wireless communication network, and a path loss between the communication device of the first wireless communication network and the communication device of the second wireless communication network.

According to another aspect, there is also provided an apparatus for assessing an interference effect, the apparatus including a processor, wherein the processor is configured to set, to determine an interference effect exerted by at least one communication device of a first wireless communication network on a fixed communication device previously arranged in a second wireless communication network, a parameter associated with the communication device of the first wireless communication network and the communication device of the second wireless communication network, generate, for each snapshot, an arrangement state of the communication device of the first wireless communication network arranged based on the communication device of the second wireless communication network, and assessing an interference effect of the communication device of the first wireless communication network on the communication device of the second wireless communication network on a time-by-time basis.

In the arrangement state, the communication device of the first wireless communication network is arranged beyond a separation distance from the communication device of the second wireless network within a simulation distance.

The processor may be configured to determine an adequacy of the separation distance by determining whether an interference effect of the arranged communication device of the first wireless communication network on the communication device of the second wireless communication network satisfies an acceptable interference criterion.

The communication device of the first wireless communication network and the communication device of the second wireless communication network may use a same frequency band or neighboring frequency bands.

The parameter may include a transmission power and a beamforming gain of the communication device of the first wireless communication network, an antenna gain of the communication device of the second wireless communication network, and a path loss between the communication device of the first wireless communication network and the communication device of the second wireless communication network.

The processor may be configured to assess the interference effect on the time-by-time basis using an interference signal intensity corresponding to the communication device of the first wireless communication network for each time step given for each snapshot.

The interference signal intensity may be determined based on an antenna gain of the communication device of the second wireless communication network and a path loss between the communication device of the first wireless communication network and the communication device of the second wireless communication network.

According to another aspect, there is also provided an apparatus for assessing an interference effect, the apparatus including a processor, wherein the processor is configured to set, to determine an interference effect exerted by a fixed communication device previously arranged in a second wireless communication network on at least one communication device to be arranged in a first wireless communication device, a parameter associated with the communication device of the first wireless communication network and the communication device of the second wireless communication network, generate, for each snapshot, an arrangement state of the communication device of the first wireless communication network to be arranged beyond a separation distance within a simulation distance based on the communication device of the second wireless communication network, and assess an interference effect exerted by the communication device of the second wireless communication network on the communication device of the first wireless communication network on a time-by-time basis.

The communication device of the first wireless communication network and the communication device of the second wireless communication network may use a same frequency band or neighboring frequency bands.

The parameter may include a transmission power and a beamforming gain of the communication device of the first wireless communication network, an antenna gain of the communication device of the second wireless communication network, and a path loss between the communication device of the first wireless communication network and the communication device of the second wireless communication network.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating data transmission and reception between a first wire communication network and a second wireless communication network according to an example embodiment;

FIG. 2 is a diagram illustrating a base station arrangement for assessing an interference effect of a base station located around a receiving station according to an example embodiment;

FIG. 3A is a diagram illustrating an intensity of an interference signal acquired at one snapshot using a Monte Carlo method according to an example embodiment;

FIG. 3B is a diagram illustrating an intensity of an interference signal acquired for each time step given at one snapshot based on a time percentage according to an example embodiment;

FIG. 4 is a diagram illustrating a method performed by an interference effect assessing apparatus to assess an interference effect exerted by a base station and a terminal on a receiving station based on a time percentage according to an example embodiment;

FIG. 5 is a diagram illustrating a separation distance assessing process performed by an interference effect assessing apparatus according to an example embodiment; and

FIG. 6 is a diagram illustrating an interference effect assessing method performed by an interference effect assessing apparatus according to an example embodiment.

### DETAILED DESCRIPTION

Detailed example embodiments of the inventive concepts are disclosed herein. However, specific structural and functional details disclosed herein are merely representative for purposes of describing example embodiments of the inventive concepts. Example embodiments of the inventive concepts may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

It will be understood that when an element is referred to as being “connected” or “coupled” to another element, it may be directly connected or coupled to the other element or intervening elements may be present.

The terminology used herein is for the purpose of describing particular embodiments only and is not intended to be limiting of example embodiments of the inventive concepts. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings.

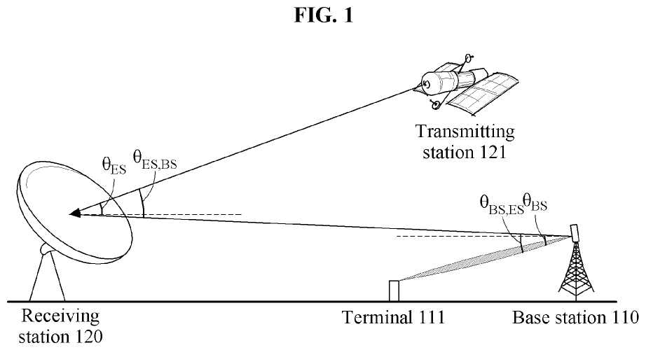

FIG. 1 is a diagram illustrating data transmission and reception between a first wire communication network and a second wireless communication network according to an example embodiment.

A first wireless communication network may include a communication device. The communication device of the first wireless communication network may be, for example, a base station 110 and a terminal 111 and include a communication device configuring a mobile communication system. An interference may occur in a second wireless communication network due to data transmission and reception performed between the base station 110 and the terminal 111 which are the communication device of the first wireless communication network.

The first wireless communication network and the second wireless communication network may transmit and receive data using the same frequency band or neighboring frequency bands. For example, the communication device included in the first wireless communication network may perform a fifth-generation (5G) mobile communication.

The second wireless communication network may include a communication device. The communication device of the second wireless communication network may be, for example, a receiving station 120 and a transmitting station 121. An interference effect may be exerted on the receiving station 120 and the transmitting station 121 which are the communication device of the second wireless communication network due to the first wireless communication network.

For example, the communication device included in the second wireless communication network may perform a satellite communication. In this example, the receiving station 120 which is the communication device of the second wireless communication network used for the satellite communication may be a fixed device. Also, the transmitting station 121 may be an unfixed device such as a satellite.

The receiving station 120 which is the communication device of the second wireless communication network may be fixed in advance. The base station 110 which is the communication device of the first wireless communication network may be expected to be arranged. Thus, an assessment of the interference effect exerted by the base station 110 which is the communication device of the first wireless communication network on the receiving station 120 of the second wireless communication network may be required.

In this example, the base station 110 may be arranged at an appropriate separation distance from the receiving station 120 such that the interference effect exerted by the base station 110 which is the communication device of the first wireless communication network on the receiving station 120 of the second wireless communication network is less than or equal to an acceptable interference criterion.

The base station 110 included in the first wireless communication network may track a location of the terminal 111 in real time and perform a beamforming by applying the location of the terminal 111 to transmit and receive data. Through the beamforming, the receiving station 120 may receive the interference effect based on a signal transmitted by the base station 110 to the terminal 111. Thus, the base station 110 may be arranged based on the appropriate separation distance such that the interference effect received by the receiving station 120 is less than or equal to the acceptable interference criterion.

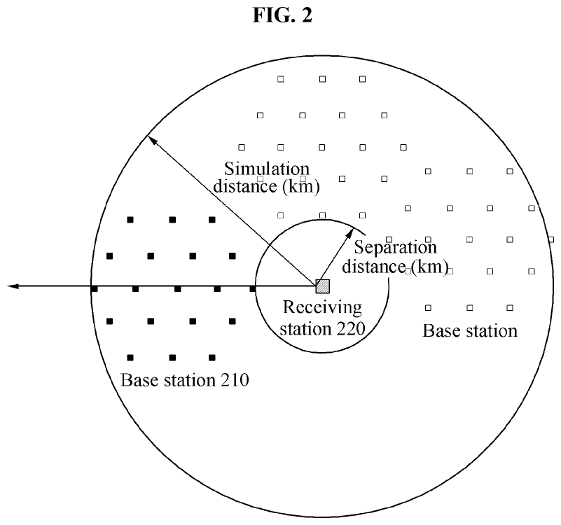

FIG. 2 is a diagram illustrating a base station arrangement for assessing an interference effect of a base station located around a receiving station according to an example embodiment.

Referring to FIG. 2, a base station 210 corresponding to a communication device of a first wireless communication network may be located around a receiving station 220 corresponding to a communication device of a second wireless communication network. In this example, an interference effect of at least one base station 210 may be exerted on the receiving station 220. The base station 210 may be located beyond a separation distance from the receiving station 220 within a simulation distance, the separation distance and the simulation distance being in units of, for example, kilometers (km). Also, at least one base station 210 may be arranged around the receiving station 220. Here, the simulation distance may be a distance set by a user. Also, the separation distance may be a distance in which an intensity of an interference signal received by the receiving station due to the base station is less than or equal to an acceptable interference criterion.

The base station 210 may not be located within a predetermined distance from the receiving station 220. The predetermined distance may include the separation distance. The base station 210 may not be located within the separation distance from the receiving station 220. Also, the interference effect of the base station 210 located within the separation distance and the simulation distance may be exerted on the receiving station 220.

The base station 210 may be arranged based on the receiving station 220. The base station 210 may be randomly arranged in an area around the receiving station 220 beyond the separation distance within the simulation distance so as to have a uniform distribution.

An intensity of an interference signal transmitted from the base station 210 to the receiving station 220 may be determined using Equation 1. In Equation 1, θ_{BS,ES} denotes a relative azimuth angle of an antenna of a base station toward an antenna of a receiving station of a satellite communication, θ_{ES,BS} denotes a relative azimuth angle of the antenna of the receiving station of the satellite communication toward the antenna of the base station, ϕ_{BS,ES} denotes an relative elevation angle of the antenna of the base station toward the antenna of the receiving station of the satellite communication, ϕ_{ES,BS} denotes a relative elevation angle of the antenna of the receiving station of the satellite communication toward the antenna of the base station, and d_{5G,ES}(t) denotes a distance between the base station and the receiving station of the satellite communication.

$${I}_{es} ( t ) = \frac{\begin{matrix}{P}_{T , 5 G} ( t ) {G}_{5 G} \{ ( {θ}_{BS , ES} , {φ}_{BS , ES} ) , t \} \\ {G}_{ES} \{ ( {θ}_{ES , BS} , {φ}_{ES , BS} ) , t \}\end{matrix}}{{PL}_{5 G , ES} ( {d}_{5 G , ES} ( t ) )} \qquad [ Equation 1 ]$$

In Equation 1, P_{T,5G}(t) denotes transmission power in the base station 210 and may be a value varying with time based on traffic (for example, a network loading rate or a base station loading rate). G_{5G} denotes a beamforming gain obtained in a direction from the base station 210 to the receiving station 220 when the base station 210 of the first wireless communication network performs the beamforming. G_{ES} denotes an antenna gain obtained in a direction from the base station 210 to the receiving station 220. PL_{5G,ES} denotes a path loss between the base station 210 and the receiving station 220.

Even when the terminal 111 moves or stops over time, the beamforming gain from the base station 210 to the terminal 111 may vary based on an object moving in a vicinity. In this example, the beamforming gain of the base station 210 may also vary in a direction of the antenna of the receiving station 220. Here, the elevation angle and the azimuth angle of the antenna of the receiving station 220 may have a fixed value corresponding to a transmitter characteristic of the receiving station 220, or may be a value varying on a time-by-time basis.

Similar to G_{5G}, G_{ES} denotes an antenna gain varying with time in the direction from the antenna of the receiving station 220 to the base station 210 based on the beamforming gain between the base station 210 and the terminal 111 changing the time-by-time basis.

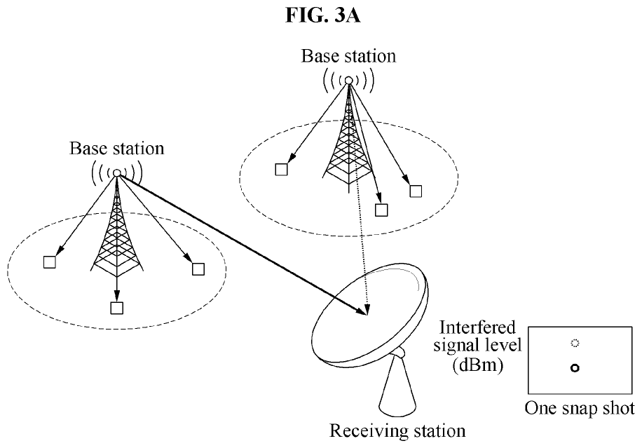

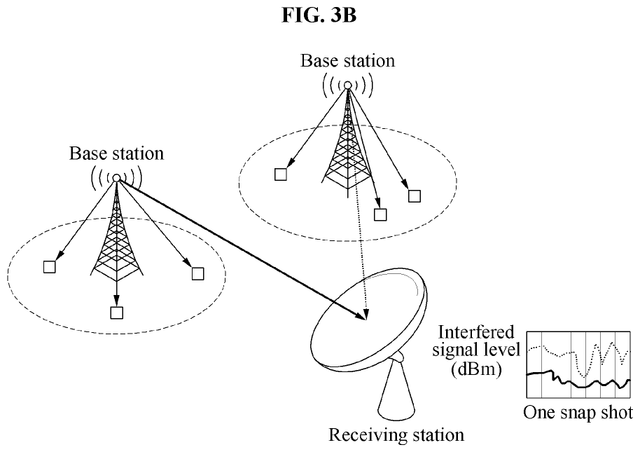

FIG. 3A is a diagram illustrating an intensity of an interference signal acquired at one snapshot using a Monte Carlo method according to an example embodiment and FIG. 3B is a diagram illustrating an intensity of an interference signal acquired for each time step given at one snapshot based on a time percentage according to an example embodiment. FIGS. 3A and 3B may be based on the receiving station 220 that receives an interference signal from at least one base station of FIG. 2.

One snapshot may indicate a simulation performed in a predetermined time (t=t₀). In this example, a snapshot for a predetermined time (t=t₁) may be independent of a snapshot for the predetermined time (t=t₀).

The interference effect assessing apparatus may assess an interference effect of a parameter such as t_{0_0}, t_{0_1}, and t_{0_2} changing during a time step in the predetermined time (t=t₀). In the snapshot, a position of a based station, a terminal, and/or a receiving station may be generated, the parameter may change based on a relationship with the position of the terminal during the time step, and a network loading rate of the base station may also change. Also, since the position of the terminal changes, an antenna gain may also change during the time step.

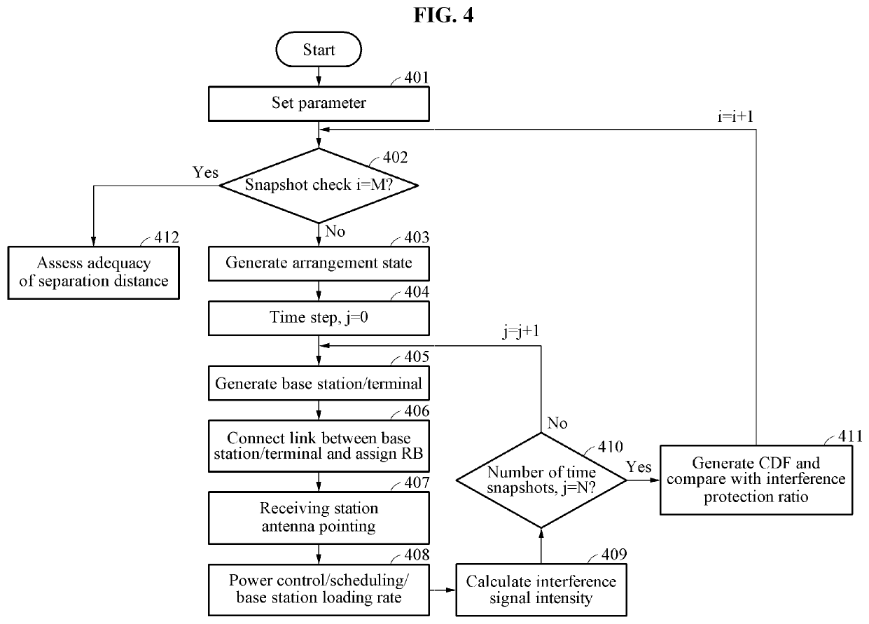

FIG. 4 is a diagram illustrating a method performed by an interference effect assessing apparatus to assess an interference effect exerted by a base station and a terminal on a receiving station based on a time percentage according to an example embodiment. The interference effect assessing apparatus may be located in the receiving station, the base station, or the terminal. The interference effect assessing apparatus may also be located external to the receiving station, the base station, or the terminal.

In operation 401, the interference effect assessing apparatus may set a parameter associated with the receiving station, the base station, and the terminal. The parameter may include a transmission power, an antenna pattern, an antenna pointing elevation angle, an antenna height, and a propagation model for each path.

The transmission power may be a transmission power of the transmitting station 121 or the base station 110. In terms of uplink, the transmission power may be a transmission power of the terminal. The antenna pattern, the antenna pointing elevation angle, and the antenna height may be a parameter associated with an antenna of the receiving station 120. Also, in the propagation model for each pattern, a path may be i) a path between the transmitting station 121 and the receiving station 120, ii) a path between the base station 110 and the terminal 111, and iii) a path between the base station 110 and the receiving station 120.

In operation 402, the interference effect assessing apparatus may perform a snapshot check. The snapshot check may be performed by checking a number of snapshots. The number of snapshots may be a total number of snapshots input by a user to be used for simulation.

In operation 403, the interference effect assessing apparatus may generate an arrangement state of the base station for each snapshot. As described with reference to FIG. 2, the interference effect assessing apparatus may generate a location of a cluster of the base station located within a simulation distance and a separation distance based on the receiving station. The cluster of the base station may be an area in which the base station is to be located. A location of the base station, an antenna direction of the base station, a distance between the base station and the receiving station, and an azimuth angle of the cluster may be randomly determined.

In operation 404, the interference effect assessing apparatus may start a time loop. A minimum time step may be determined using Equation 2. A time step may be determined to be greater than or equal to the minimum time step. For example, when an interference criteria exceedance percentage is 0.01%, the minimum time step may be determined to be 10000 (=100/0.01). The interference criteria exceedance percentage may be one of interference criteria. In general, a parameter associated with a performance such as I/N and C/I may be used as the interference criterion. When an interference analysis is performed in terms of time, a time percentage interference criterion may exist and thus, the interference criteria exceedance percentage may be determined based on the time percentage interference criterion.

Time step=100/interference criteria exceedance percentage [Equation 2]

In operation 405, the interference effect assessing apparatus may generate a base station sector in the cluster of the base station generated in operation 403 and generate a terminal for each sector. A position of the terminal may be randomly generated to have a uniform value between [−60, +60] for each time step. This indicates that the terminal is located at an azimuth angle between −60 degrees)(° and 60° based on a center of the base station sector. In this example, a distance between the base station and the terminal may be randomly generated to have a uniform distribution or a Rayleigh distribution value.

In operation 406, the interference effect assessing apparatus may connect a link between the base station and the terminal and assign a resource block. The interference effect assessing apparatus may calculate a path loss value between the base station and the terminal for each path between each base station sector and a selected terminal. In this example, when a number of resource blocks requiring the terminal and a number of resource blocks to be provided by the base station are same based on the base station having a smallest path loss value, the interference effect assessing apparatus may connect a link between the base station and the terminal.

When the link is connected, an antenna gain may be formed based on positions and heights of the base station and the terminal using Equation 3.

$${G}_{5 G} ( {θ}_{BS} , {ϕ}_{BS} ) = {A}_{E} ( {θ}_{BS} , {ϕ}_{BS} ) + 10 {log}_{10} ( {\vert {\sum }_{m = 1}^{{N}_{H}} {\sum }_{n = 1}^{{N}_{V}} {w}_{i , n , m} \cdot {v}_{n , m} \vert}^{2} ) \qquad [ Equation 3 ]$$

In Equation 3, A_{E}(θ_{BS}, φ_{BS}) denotes an element pattern of the base station and

$$10 {log}_{10} ( {\vert {\sum }_{m = 1}^{{N}_{H}} {\sum }_{n = 1}^{{N}_{V}} {w}_{i , n , m} \cdot {v}_{n , m} \vert}^{2} )$$

denotes a logarithmic sum of array gains. Also, Also, an overlapping vector [symbol] _{n,m} and a weight [symbol] _{i,n,m} may be obtained using an equation in related documents. Here, the overlapping vector [symbol] _{n,m} may be determined using Equation a and the weight [symbol] _{i,n,m} may be determined using Equation b.

$$\begin{matrix}{v}_{n , m} = exp ( \sqrt{- 1} \times 2 π \times ( ( n - 1 ) \times \frac{{d}_{V}}{λ} \times cos ( θ ) + ( m - 1 ) \times \frac{{d}_{H}}{λ} \times sin ( θ ) \times sin ( ϕ ) ) ) & [ Equation a ] \\ {w}_{i , n , m} = \frac{1}{\sqrt{{N}_{H} \times {N}_{V}}} exp ( \sqrt{- 1} \times 2 π \times ( ( n - 1 ) \times \frac{{d}_{V}}{λ} \times sin ( {θ}_{i , etilt} ) - ( m - 1 ) \times \frac{{d}_{H}}{λ} \times cos ( {θ}_{i , etilt} ) \times sin ( {ϕ}_{i , escan} ) ) ) & [ Equation b ]\end{matrix}$$

In operation 407, the interference effect assessing apparatus may perform pointing such that a receiving station antenna is in a direction of a transmitting station that transmits to and receives from the receiving station of the second wireless communication network.

In one example, when the second wireless communication network is used for a satellite communication, and when a satellite corresponding to the transmitting station transmits data to a satellite earth station using a geostationary orbit, the antenna of the receiving station may point to the satellite corresponding to the transmitting station. In another example, when the satellite corresponding to the transmitting station transmits data to the satellite earth station corresponding to the receiving station using the non-geostationary orbit, the antenna of the receiving station may point to the satellite following a position of a non-geostationary orbit.

In operation 408, the interference effect assessing apparatus may determine a transmission power for each terminal link-connected to the base station using Equation 4. For example, in terms of the uplink, the transmission power may be determined for each terminal link-connected to each base station using Equation 4.

$${P}_{t \_ UE} ( time\_step ) = {P}_{m ax} \times min \{ 1 , max [ {R}_{m i n} , {( \frac{PL}{{PL}_{X - ile}} )}^{γ} ] \} \qquad [ Equation 4 ]$$

In Equation 4, Pₘₐₓ denotes a maximum transmission power of a terminal, Rₘᵢₙ denotes a minimum power level of the terminal, PL_{denotes} a path loss between the terminal and a base station, PL_{X-ile} denotes 88+10*log 10(200/bandwidth), and γ denotes an adjustment factor with respect to terminals in a good channel and a bad channel. Here, a large path loss may correspond to a case in which an intensity of a base station signal received by the terminal is small and may be transmitted at a high power of the terminal. Also, a small path loss may correspond to a case in which an intensity of a base station signal received by the terminal is large and may be transmitted at a low power of the terminal. In this example, the minimum power level may be a threshold between the low power and the high power of the terminal.

The interference effect assessing apparatus may determine a base station loading percentage based on three methods such as i) a case in which all base stations have a base station loading percentage of 100%, ii) a case in which all base stations select base station loading percentages (x %) as random values for each time step, and iii) a case in which the base station loading percentage (x %) is generated as a random value for each base station.

A transmission power value of the base station may be determined based on a value of the base station loading percentage (x %) using Equation 5.

P_{t_Bs}(time_step)=Pₘₐₓ×(x/100) [Equation 5]

In operation 409, the interference effect assessing apparatus may determine intensities of interference signals received from all base stations or terminals for each time step using Equation 1 by obtaining the antenna gain and the path loss value for each path.

In operation 410, the interference effect assessing apparatus may verify whether the simulation is performed by a time step. In operation 411, when the simulation is performed by the time step, the interference effect assessing apparatus may generate a cumulative density function (CDF) of the intensity of the interference signal received from all the base station and determine whether an interference protection ratio corresponding to an input time exceeding percentage is satisfied. Here, as a widely used meaning, the CDF may indicate “a value obtained by integrating a function representing a nonexceedance probability or a probability density function at a lower limitation of a domain.” Also, the interference protection ratio may indicate a criterion such as an interference signal intensity to be accepted in a system and an interference signal intensity not to be accepted in a system.

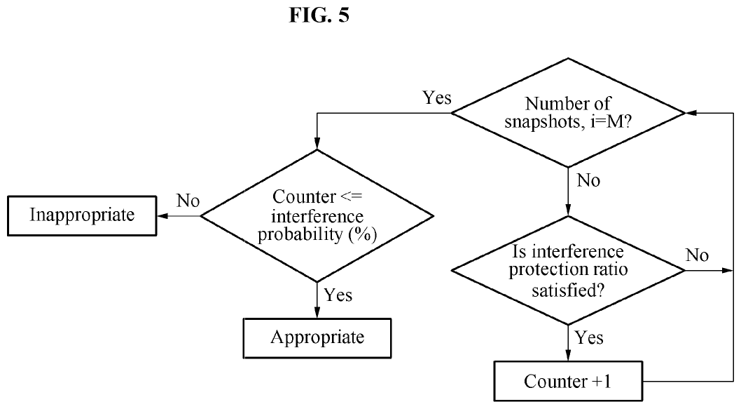

In operation 412, the interference effect assessing apparatus may assess an adequacy of a separation distance by repetitively verifying whether the acceptable interference criterion is satisfied at the separation distance for each snapshot. Operation 412 will be further described with reference to FIG. 5.

FIG. 5 is a diagram illustrating a separation distance assessing process performed by an interference effect assessing apparatus according to an example embodiment.

A number of snapshots may be a total number of simulations. Also, a counter may be a result obtained by counting the number of snapshots satisfying an interference protection ratio. For example, if the total number of snapshots=10000 and the counter=10, an interference probability may be calculated to be 0.1%. If an acceptable interference criterion is 0.01%, the calculated interference probability of 0.1% may be inappropriate and thus, a simulation may be reperformed based on a new separation distance.

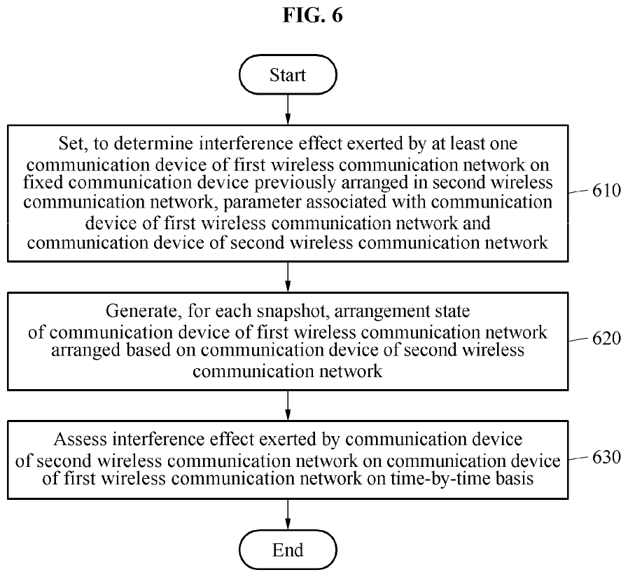

FIG. 6 is a diagram illustrating an interference effect assessing method performed by an interference effect assessing apparatus according to an example embodiment.

In operation 610, to determine an interference effect exerted by at least one communication device of a first wireless communication network on a fixed communication device previously arranged in a second wireless communication network, an interference effect assessing apparatus may set a parameter associated with the communication device of the first wireless communication network and the communication device of the second wireless communication network.

The communication device of the first wireless communication network may include, for example, a base station and a terminal of a mobile communication system. The communication device of the second wireless communication network may include, for example, a transmitting station and a receiving station of a satellite communication. Here, the communication device of the first wireless communication network and the communication device of the second wireless communication network may use a same frequency band or neighboring frequency bands.

The parameter may include a transmission power and a beamforming gain of the communication device of the first wireless communication network, an antenna gain of the communication device of the second wireless communication network, and a path loss between the communication device of the first wireless communication network and the communication device of the second wireless communication network.

In operation 620, the interference effect assessing apparatus may generate, for each snapshot, an arrangement state of the communication device of the first wireless communication network arranged based on the communication device of the second wireless communication network.

In the arrangement state, the communication device of the first wireless communication network may be arranged at a distance less than a simulation distance and greater than a separation distance from the communication device of the second wireless network. For example, the base station of the first wireless communication network may be arranged beyond a separation distance within a simulation distance based on the receiving station of the second wireless communication network. Thus, by assessing an interference effect of the base station on the receiving station, the interference effect assessing apparatus may determine whether the separation distance is appropriate.

In operation 630, the interference effect assessing apparatus may assess an interference effect exerted by the communication device of the second wireless communication network on the communication device of the first wireless communication network on a time-by-time basis.

The interference effect assessing apparatus may assess the interference effect on the time-by-time basis using an interference signal intensity corresponding to the communication device of the first wireless communication network for each time step given for each snapshot. The interference signal intensity may be determined using Equation 1.

According to example embodiments, it is possible to assess an interference effect exerted by a mobile communication system on a fixed system based on a time percentage.

According to example embodiment, it is possible to provide a good quality service by analyzing an interference effect exerted by a mobile communication system on a fixed system using the same frequency band or a neighboring frequency band as compared to that of the mobile communication system.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of assessing an interference effect, the method comprising:
setting, to determine an interference effect exerted by at least one communication device of a first wireless communication network on a fixed communication device previously arranged in a second wireless communication network, a parameter associated with the communication device of the first wireless communication network and the communication device of the second wireless communication network;
generating, for each snapshot, an arrangement state of the communication device of the first wireless communication network arranged based on the communication device of the second wireless communication network; and
assessing an interference effect of the communication device of the first wireless communication network on the communication device of the second wireless communication network on a time-by-time basis.

2. The method of claim 1, wherein, in the arrangement state, the communication device of the first wireless communication network is arranged beyond a separation distance from the communication device of the second wireless network within a simulation distance.

3. The method of claim 2, further comprising:
determining an adequacy of the separation distance by determining whether an interference effect of the arranged communication device of the first wireless communication network on the communication device of the second wireless communication network satisfies an acceptable interference criterion.

4. The method of claim 1, wherein the communication device of the first wireless communication network and the communication device of the second wireless communication network use a same frequency band or neighboring frequency bands.

5. The method of claim 1, wherein the parameter includes a transmission power and a beamforming gain of the communication device of the first wireless communication network, an antenna gain of the communication device of the second wireless communication network, and a path loss between the communication device of the first wireless communication network and the communication device of the second wireless communication network.

6. The method of claim 1, wherein the assessing of the interference effect comprises:
assessing the interference effect on the time-by-time basis using an interference signal intensity corresponding to the communication device of the first wireless communication network for each time step given for each snapshot.

7. The method of claim 6, wherein the interference signal intensity is determined based on an antenna gain of the communication device of the second wireless communication network and a path loss between the communication device of the first wireless communication network and the communication device of the second wireless communication network.

8. A method of assessing an interference effect, the method comprising:
setting, to determine an interference effect exerted by a fixed communication device previously arranged in a second wireless communication network on at least one communication device to be arranged in a first wireless communication device, a parameter associated with the communication device of the first wireless communication network and the communication device of the second wireless communication network;
generating, for each snapshot, an arrangement state of the communication device of the first wireless communication network to be arranged beyond a separation distance within a simulation distance based on the communication device of the second wireless communication network; and
assessing an interference effect exerted by the communication device of the second wireless communication network on the communication device of the first wireless communication network on a time-by-time basis.

9. The method of claim 8, wherein the communication device of the first wireless communication network and the communication device of the second wireless communication network use a same frequency band or neighboring frequency bands.

10. The method of claim 8, wherein the parameter includes a transmission power and a beamforming gain of the communication device of the first wireless communication network, an antenna gain of the communication device of the second wireless communication network, and a path loss between the communication device of the first wireless communication network and the communication device of the second wireless communication network.

11. An apparatus for assessing an interference effect, the apparatus comprising:
a processor,
wherein the processor is configured to:
set, to determine an interference effect exerted by at least one communication device of a first wireless communication network on a fixed communication device previously arranged in a second wireless communication network, a parameter associated with the communication device of the first wireless communication network and the communication device of the second wireless communication network;
generate, for each snapshot, an arrangement state of the communication device of the first wireless communication network arranged based on the communication device of the second wireless communication network; and
assessing an interference effect of the communication device of the first wireless communication network on the communication device of the second wireless communication network on a time-by-time basis.

12. The apparatus of claim 11, wherein, in the arrangement state, the communication device of the first wireless communication network is arranged beyond a separation distance from the communication device of the second wireless network within a simulation distance.

13. The apparatus of claim 12, wherein the processor is configured to determine an adequacy of the separation distance by determining whether an interference effect of the arranged communication device of the first wireless communication network on the communication device of the second wireless communication network satisfies an acceptable interference criterion.

14. The apparatus of claim 11, wherein the communication device of the first wireless communication network and the communication device of the second wireless communication network use a same frequency band or neighboring frequency bands.

15. The apparatus of claim 11, wherein the parameter includes a transmission power and a beamforming gain of the communication device of the first wireless communication network, an antenna gain of the communication device of the second wireless communication network, and a path loss between the communication device of the first wireless communication network and the communication device of the second wireless communication network.

16. The apparatus of claim 11, wherein the processor is configured to assess the interference effect on the time-by-time basis using an interference signal intensity corresponding to the communication device of the first wireless communication network for each time step given for each snapshot.

17. The apparatus of claim 16, wherein the interference signal intensity is determined based on an antenna gain of the communication device of the second wireless communication network and a path loss between the communication device of the first wireless communication network and the communication device of the second wireless communication network.
